(19) United States
(12) Patent Application Publication
(10) Pub. No.: US 2025/0301539 A1
(43) Pub. Date: Sep. 25, 2025

(54) CERAMIC HEATER

(71) Applicant: Niterra Co., Ltd., Nagoya-shi (JP)

(72) Inventor: Hiroki HATTORI, Nagoya-shi (JP)

(21) Appl. No.: 19/081,729

(22) Filed: Mar. 17, 2025

(30) Foreign Application Priority Data
Mar. 19, 2024 (JP) 2024-043167
Oct. 16, 2024 (JP) 2024-180509

(51) Int. Cl. H05B 3/14; H05B 3/50

(52) U.S. Cl. CPC H05B 3/141; H05B 3/50

(57) ABSTRACT

A ceramic heater for liquid heating includes a circular columnar ceramic body extending in an axial-line direction and including a heat generation resistor element, and a heat radiation fin member which protrudes from a surface of the ceramic body and is higher in thermal conductivity than the ceramic body.

### TECHNICAL FIELD

The present invention relates to a ceramic heater for liquid heating which is used for air conditioning of, for example, an electric vehicle, heating and temperature keeping of a battery, or the like.

### BACKGROUND ART

There has been studied a system in which a medium such as a coolant liquid is heated with a ceramic heater for air conditioning of an electric vehicle or heating and temperature keeping of a battery. In particular, since the performance of the battery decreases in cold regions, heating and temperature keeping of the battery are important.

Such a ceramic heater has, for example, a structure in which a ceramic layer is wound around the outer periphery of a tubular or columnar ceramic tube serving as a core, and a heat generation resistor element having a predetermined heater pattern is formed in the ceramic layer (see Patent Document 1). When electricity is supplied to the heat generation resistor element, the ceramic heater generates heat.

### PRIOR ART

Patent Document 1 is Japanese Patent Application Laid-Open (kokai) No. 2019-133762.

### SUMMARY OF THE INVENTION

By the way, in the case where a ceramic heater is used for heating a medium (liquid) such as coolant liquid, when the flow rate of the liquid flowing around the ceramic heater decreases or when the amount of the liquid within a container decreases due to, for example, leakage of the liquid, overboiling occurs and the heater comes into a state of heating with no liquid (air heating state).

As a result, the surface of the ceramic heater becomes hot, and, if a droplet of the liquid comes into contact with the hot (high temperature) portion, there arises a possibility that a crack or the like is generated in the heater due to thermal shock and the heater is broken.

In view of the above, an object of the present invention is to provide a ceramic heater for liquid heating which is prevented from being broken even in the state of heating with no liquid.

In order to solve the above problem, a ceramic heater of the present invention is a ceramic heater for liquid heating, comprising: a circular columnar ceramic body extending in an axial-line direction and including a heat generation resistor element; and a heat radiation fin member which protrudes from a surface of the ceramic body and is higher in thermal conductivity than the ceramic body.

According to this ceramic heater, the heat radiation fin member protrudes from the surfaces of the ceramic body. Therefore, even when the ceramic heater comes into a state of heating with no liquid (air heating state) and the ceramic body which forms the surface of the ceramic heater becomes high temperature, breakage of the ceramic heater due to droplets of the liquid can be prevented. Specifically, since the droplets of the liquid do not come into direct contact with the high temperature portion but come into contact with the heat radiation fin member and are cooled. Therefore, it is possible to prevent generation of a crack or the like in the heater due to thermal shock, which would otherwise result in breakage of the heater.

In addition, since the ceramic heater (the ceramic body) itself is cooled by the heat radiation fin member, overheating of the ceramic heater can be suppressed.

In the ceramic heater of the present invention, the heat radiation fin member may have a fin portion and a base portion to which the fin portion is fixed, the entire surface of the ceramic body may be covered by the fin portion and the base portion, and the ceramic heater may further comprise a seal member which can maintain liquid tightness between the surface of the ceramic body and the heat radiation fin member.

According to this ceramic heater, it is possible to prevent the liquid from entering the gaps between the ceramic body and the heat radiation fin member, thereby preventing boiling of the liquid in the gaps, which would otherwise cause overheating of the heater.

In the ceramic heater of the present invention, the heat radiation fin member may be formed of aluminum or an aluminum alloy, and a surface of the heat radiation fin member may be anodized.

According to this ceramic heater, since the thermal conductivity of the heat radiation fin member increases, the heat radiation effect is enhanced, and alumite treatment (anodizing) suppresses corrosion of the heat radiation fin member by a liquid such as coolant.

In the ceramic heater of the present invention, the entire surface of the ceramic body may be covered by the base portion, and the fin portion may be a member which is separate from the base portion and protrudes from the base portion.

According to this ceramic heater, the ceramic heater can have a structure in which the fin portion, which is a portion different from the base portion, is fixed to the base portion, and the ceramic heater enables replacement of, for example, a broken fin portion.

The present invention can provide a ceramic heater for liquid heating which is prevented from being broken even in the state of heating with no liquid.

### BRIEF DESCRIPTION OF THE DRAWINGS

FIG. 1 is a perspective view showing a ceramic heater according to an embodiment of the present invention.

FIG. 2 is a front view of the ceramic heater as viewed from its forward end.

FIG. 3 is a sectional view along line A-A in FIG. 1.

FIG. 4 is a perspective view showing the configuration of a ceramic body.

### DESCRIPTION OF THE INVENTION

Hereinafter, an embodiment of the present invention will be described.

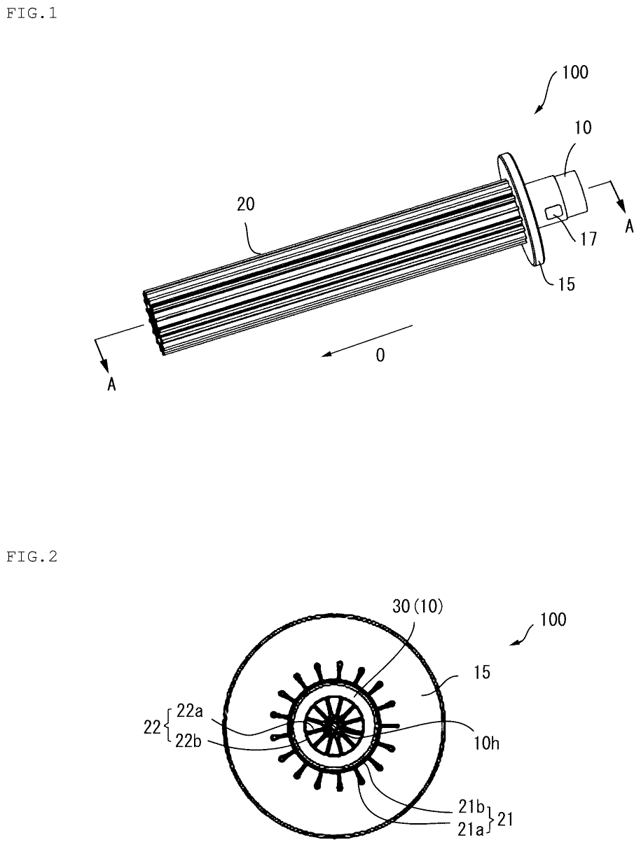

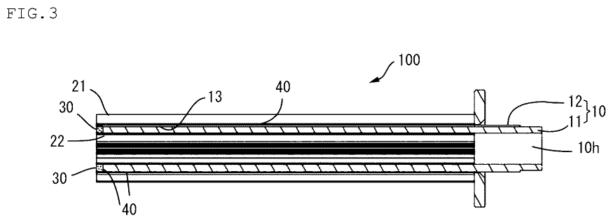

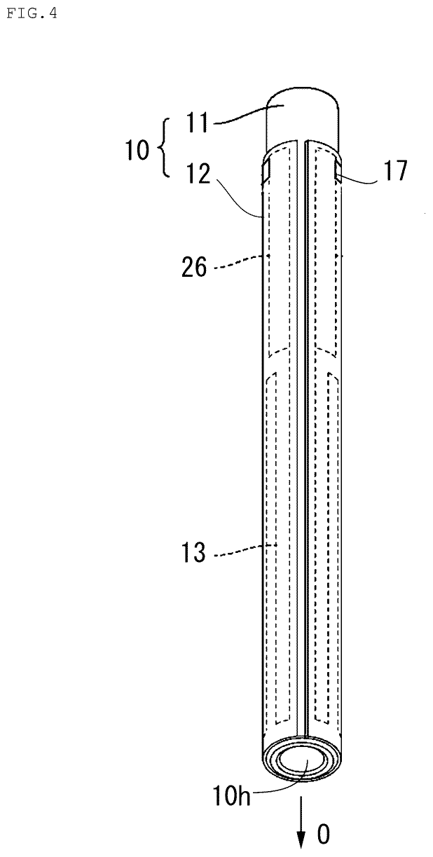

FIG. 1 is a perspective view showing a ceramic heater 100 according to an embodiment of the present invention. FIG. 2 is a front view of the ceramic heater 100 as viewed from its forward end. FIG. 3 is a sectional view along line A-A in FIG. 1. FIG. 4 is a perspective view showing the configuration of a ceramic body 10.

The ceramic heater 100 of this embodiment can be used for air conditioning of, for example, an electric vehicle, heating and temperature keeping of a battery, or the like. The ceramic heater 100 is adapted for liquid heating and heats a liquid such as coolant liquid, thereby heating an object to be heated via the liquid.

As shown in FIG. 1, the ceramic heater 100 includes a circular columnar ceramic body 10 extending in an axial-line O direction, and heat radiation fin members 20 attached in such a manner that the heat radiation fin members 20 protrude from the surfaces of the ceramic body 10. Notably, in the present example, the heat radiation fin members 20 cover the surfaces of the ceramic body 10.

The heat radiation fins member 20 are formed of a material whose thermal conductivity is higher than that of the ceramic body, and, for example, a metal such as aluminum may be used.

A heat generation resistor element 13 is embedded in the ceramic body 10 (FIG. 3).

Here, the term “circular column” encompasses “cylinder.”

A pair of external terminals 17 (only one external terminal is shown in FIG. 1) for supplying electricity to the heat generation resistor element 13 are exposed on the outer surface of a portion of the ceramic body 10 on one end side (a rear end side).

An annular flange portion 15 formed of a ceramic material and used for attaching the ceramic heater 100 to an object (for example, an electric vehicle), to which the ceramic heater 100 is to be attached, is fitted onto a portion of the ceramic body 10, which portion is located slightly forward of the external terminals 17. The flange portion 15 is fixed to that portion of the ceramic body 10 by glass or the like.

The heat radiation fin members 20 cover the surfaces of the ceramic body 10 on a forward end side of the flange portion 15.

As shown in FIGS. 2 and 3, in the present example, the ceramic body 10 has a cylindrical shape and has a through hole 10h at its center. A liquid flowing inside the through hole 10h is heated by the ceramic heater 100, and the liquid on an outer peripheral side of the ceramic heater 100 is also heated by the ceramic heater 100.

The heat radiation fin members 20 are composed of a first heat radiation fin member 21 which covers the outer surface of the ceramic body 10 and a second heat radiation fin member 22 which covers the inner surface of the ceramic body 10 (the wall surface of the through hole 10h).

An end surface (surface facing toward the forward end) of the ceramic body 10 is covered with a waterproof cap 30 formed of a material having a higher thermal conductivity than the ceramic body 10, such as an aluminum alloy or a copper alloy.

The first heat radiation fin member 21 has a cylindrical base portion 21b extending along the outer surface of the ceramic body 10 and a plurality of fin portions 21a integrally provided on the base portion 21b such that the fin portions 21a protrude outward from the outer surface of the base portion 21b. The fin portions 21a are disposed such that they are separated from one another in the circumferential direction of the base portion 21b.

Similarly, the second heat radiation fin member 22 has a cylindrical base portion 22b extending along the inner surface of the ceramic body 10 and a plurality of fin portions 22a integrally provided on the base portion 22b such that the fin portions 22a protrude toward the center from the inner surface of the base portion 22. The fin portions 22a are disposed such that they are separated from one another in the circumferential direction of the base portion 22b, and a gap is formed between distal ends of each pair of fin portions 22a located on opposite sides with respect the center whereby an opening is formed at the center.

Each of the gap between the first heat radiation fin member 21 and the outer surface of the ceramic body 10, the gap between the second heat radiation fin 22 and the inner surface of the ceramic body 10, and the gap between the waterproof cap 30 and the first heat radiation fin 21 and the second heat radiation fin member 22 is fixedly sealed by a liquid-tight seal member 40 (for example, epoxy resin), whereby liquid tightness is maintained at these gaps.

The seal member 40 may be formed of a material other than resin, such as thermal conductive grease, so long as liquid tightness can be secured.

Next, the structure of the ceramic body 10 will be described with reference to FIG. 4.

The ceramic body 10 includes a ceramic tube 11 and a ceramic layer (ceramic sheet) 12 which covers almost the entirety of the outer circumference of the ceramic tube 11.

The heat generation resistor element 13 having a meandering shape and a pair of internal terminals 26 are formed on the inner circumferential surface (surface on the side toward the ceramic tube 11) of the ceramic layer 12 or are formed in the ceramic layer 12. The internal terminals 26 are electrically connected to the external terminals 17 at the end of the outer circumferential surface of the ceramic layer 12 through unillustrated via conductors or the like.

The heat generation resistor element 13 is disposed in a region near the forward end of the ceramic body 10, and the external terminals 17 are disposed on the rear end side of the ceramic body 10.

The ceramic tube 11 and the ceramic layer 12 may be formed of, for example, alumina.

As described above, in the ceramic heater 100 according to the embodiment of the present invention, the heat radiation fin members 20 protrude from the surfaces of the ceramic body 10. Therefore, even when the ceramic heater 100 comes into a state of heating with no liquid (air heating state) and the surface of the ceramic heater 100 (the ceramic body 10) becomes hot, (high temperature), breakage of the ceramic heater 100 due to droplets of the liquid can be prevented. Specifically, since the droplets of the liquid do not come into direct contact with the hot (high temperature) portion but come into contact with the heat radiation fin members 20 and are cooled. Therefore, it is possible to prevent generation of a crack or the like in the heater due to thermal shock, which would otherwise result in breakage of the heater.

In addition, since the ceramic heater 100 (the ceramic body 10) itself is cooled by the heat radiation fin members 20, overheating of the ceramic heater 100 can be suppressed.

In the present example, the entire surfaces (front and back surfaces) of the ceramic body 10 are covered with the heat radiation fin members 20 (the fin portions 21a and 22a and the base portions 21b and 22b), and the sealing member 40 which can maintain liquid tightness between the surfaces (front and back surfaces) of the ceramic body 10 and the heat radiation fin members 20 is further provided.

Thus, it is possible to prevent the liquid from entering the gaps between the ceramic body 10 and the heat radiation fin members 20, thereby preventing boiling of the liquid in the gaps, which would otherwise cause overheating of the heater.

It should be understood that the present invention is not limited to the above embodiment and incorporates various modifications and equivalents within the idea and the scope of the present invention.

No limitation is imposed on the shape of the heat radiation fin members 20 so long as the heat radiation fin members 20 protrude from the surfaces of the ceramic body.

The heat radiation fin members 20 may be formed of aluminum or an aluminum alloy, and a surface of the heat radiation fin may be anodized. In this case, since the thermal conductivity of the heat radiation fin members 20 increases, the heat radiation effect is enhanced, and alumite treatment (anodizing) suppresses corrosion of the heat radiation fin members 20 by a liquid such as coolant.

The heat radiation fin members 20 can be manufactured by, for example, drawing of an aluminum material or press work in which fin portions are cut and raised from a metal plate.

### DESCRIPTION OF REFERENCE NUMERALS

10 ceramic body
13 heat generation resistor element
20,21,22 heat radiation fin members
21a, 22a fin portion
21b, 22b base portion
40 seal member
100 ceramic heater
O axial-line

What is claimed is:

1. A ceramic heater for liquid heating, comprising:
a circular columnar ceramic body extending in an axial-line direction, having a surface, and including a heat generation resistor element; and
a heat radiation fin member which protrudes from the surface of the circular columnar ceramic body and is higher in thermal conductivity than the ceramic body.

2. A ceramic heater according to claim 1, wherein
the heat radiation fin member has a fin portion and a base portion to which the fin portion is fixed,
the surface of the circular columnar ceramic body is entirely covered by the fin portion and the base portion, and
the ceramic heater further comprises a seal member which maintains liquid tightness between the surface of the circular columnar ceramic body and the heat radiation fin member.

3. A ceramic heater according to claim 1, wherein the heat radiation fin member is formed of aluminum or an aluminum alloy, and a surface of the heat radiation fin member is anodized.

4. A ceramic heater according to claim 2, wherein the heat radiation fin member is formed of aluminum or an aluminum alloy, and a surface of the heat radiation fin member is anodized.

5. A ceramic heater according to claim 2, wherein the surface of the circular columnar ceramic body is entirely covered by the base portion, and the fin portion is separate from the base portion and protrudes from the base portion.
